(19) United States
(12) Patent Application Publication
(10) Pub. No.: US 2022/0300995 A1
(43) Pub. Date: Sep. 22, 2022

(54) Method, Device and System for Disposing of a Shared Moving Object Based on Residual Value Evaluation

(71) Applicants: Hyundai Motor Company, Seoul (KR); Kia Corporation, Seoul (KR)

(72) Inventors: Jae Jun Ha, Hwaseong-si (KR); Young Jun Moon, Sejong-si (KR)

(21) Appl. No.: 17/690,237

(22) Filed: Mar. 9, 2022

(30) Foreign Application Priority Data
Mar. 16, 2021 (KR) 10-2021-0033749

(51) Int. Cl. G06Q 30/02; G06Q 30/08

(52) U.S. Cl. CPC G06Q 30/0206; G06Q 30/08

(57) ABSTRACT

An embodiment method for disposing of a shared moving object includes generating disposal registration information designating the shared moving object as an item for disposal based on a disposal due date of the shared moving object, generating market price information of the shared moving object, analyzing usage of the shared moving object according to each user device registered to a fleet system, evaluating a residual value of the shared moving object according to the usage of each user device, generating purchase benefit information of the shared moving object according to the usage, transmitting the purchase benefit information for display on the user device, and determining purchase price information according to a price based on the residual value.

### CROSS-REFERENCE TO RELATED APPLICATIONS

This application claims the benefit of Korean Patent Application No. 10-2021-0033749, filed on Mar. 16, 2021, which application is hereby incorporated herein by reference.

### TECHNICAL FIELD

The present disclosure relates to a method, device and system for disposing of a shared moving object based on residual value evaluation.

### BACKGROUND

Along with technical advances, the notion of car ownership is being weakened, while the use of shared cars is on the rise. Specifically, for the convenience of everyday life in a particular region or residence, the needs for shared vehicles and related services are increasing.

For a sharing service, an operator maintains and manages a large number of moving objects, and for the operator, a fleet system operated by a computing device comprehensively manages the reservation and maintenance of moving objects and the disposing of a moving object, of which the disposal due date is near. A computing device includes, along with a management server, a user device, which is authenticated and registered in a fleet system, and a shared moving object. A fleet system may perform data collection and exchange among a management server, a user device and a shared moving object, process such data, create a necessary output value and display the output value in a computing device.

In order to enable a computing device to efficiently manage a shared moving object for which the user's satisfaction decreases, a fleet system implements a process of checking information on the launch of a new moving object and securing the new moving object. In addition, in order to reduce burdens of data management and expense for a shared moving object with low utilization, the fleet system needs to implement a process of disposing of a shared moving object that is old or has low utilization. Disposal may be disposing for scrap or secondhand, but the fleet system may preferably apply a process of disposing of a moving object secondhand, which seems to be advantageous to an operator. The fleet system may dispose of a used moving object by using an external used vehicle sales platform or its channel. However, such disposal does not ensure a good price. Furthermore, in case a large number of used moving objects are put out for disposal, the moving object may not be disposed of. As a result, the fleet system may bear the burden of managing data of a moving object with low utilization for a long time, and a process of purchasing a new moving object may be suspended. In addition, a user device, which is found to prefer or utilize mostly a moving object to be disposed of, may not be given an opportunity to purchase the moving object, and thus a relevant user may not take a sufficient opportunity of purchase. In addition, a user device causes an inquiry request unnecessary to check whether or not a purchase process is enabled, and when many moving objects are to be disposed of, requests of many user devices may cause traffic congestion between computing devices, thereby causing a huge burden on server operation.

As a user with high usage knows details of the moving object due to characteristics of a shared moving object, a management server checks past purchase information and recognizes that the user is very likely to purchase the moving object. However, an existing application, which is implemented in a computing device in order to dispose of a shared moving object, simply provides a moving object to be disposed of to purchase list information, but no program is implemented to attract a user with high usage, which is collected through the moving object and the user device. Accordingly, a method of disposing based on residual value of a moving object is needed to encourage a user with high usage to purchase the moving object.

### SUMMARY

The present disclosure relates to a method, device and system for disposing of a shared moving object based on residual value evaluation. Particular embodiments relate to a method, device and system for disposing of a shared moving object, which is provided in a fleet system implemented by a computing device, by evaluating residual value.

A technical embodiment of the present disclosure provides a method, device and system for disposing of a shared moving object, which is provided in a fleet system implemented by a computing device, by evaluating residual value.

The technical embodiments of the present invention are not limited to the above-mentioned technical embodiments, and other technical embodiments that are not mentioned will be clearly understood by those skilled in the art through the following descriptions.

According to embodiments of the present disclosure, there is provided a method for disposing of a shared moving object according to residual value evaluation performed by a fleet system implemented by a computing device, the method comprising generating, by the computing device, disposal registration information designating the shared moving object as an item for disposal, when a disposal due date of the shared moving object is imminent, generating, by the computing device, market price information of the shared moving object, of which the disposal due date is imminent, analyzing, by the computing device, usage of the shared moving object according to each user device registered to the fleet system and evaluating residual value of the shared moving object according to the usage of each user device, and generating, by the computing device, purchase benefit information of the shared moving object, which is to be provided to the user device, according to the usage, transmitting the purchase benefit information to be displayed on the user device, and determining purchase price information according to a price based on the residual value.

According to an embodiment of the present disclosure, the evaluating of the residual value of each user may comprise calculating the residual value to be lower than the market price information, and calculating the residual value to decrease or increase according to the usage.

According to an embodiment of the present disclosure, the evaluating of the residual value of each user may comprise calculating the residual value to be lower than the market price information, applying a weight to the usage as the disposal due date becomes closer, and evaluating the residual value according to the usage to which the weight is applied.

According to an embodiment of the present disclosure, the usage may comprise at least one among a distance of use, a use period, or a number of times of use for the shared moving object, which are aggregated according to each user device.

According to an embodiment of the present disclosure, the generating of the purchase benefit information of the shared moving object for the user according to the usage may be directed to give a purchase priority to a user with highest usage among a multiplicity of users.

According to an embodiment of the present disclosure, the determining of the purchase price information according to the price based on the residual value may comprise determining an estimated price corresponding to residual value for a user accepting purchase at the request of the user device as the purchase price information.

According to an embodiment of the present disclosure, the determining of the purchase price information according to the price based on the residual value may be that purchase proceeds by an auction, when there is a multiplicity of requests of user devices participating in the purchase of the shared moving object.

The determining of the purchase price information may comprise determining a minimum bid of each request of the multiplicity of the user devices based on the residual value, receiving a requested bid equal to or greater than the minimum bid from the multiplicity of the user devices, and determining a purchaser based on the minimum bid and the requested bid, notifying the purchaser, and determining the purchaser's requested bid as purchase price information.

According to an embodiment of the present disclosure, the determining of the minimum bid may comprise setting the minimum bid to decrease as the usage increases.

According to an embodiment of the present disclosure, the determining of the purchase price information may comprise determining a user, for whom a ratio of the requested bid for the minimum bid is determined to be highest, as the purchaser.

According to an embodiment of the present disclosure, the receiving of the requested bid may comprise providing other users' requested bids and expected purchase rankings to the user device, when a user inputs a requested bid via the user device.

According to an embodiment of the present disclosure, the auction may be set, by the computing device, to proceed as a user and a non-user not registered to the fleet system participate in the auction.

According to an embodiment of the present disclosure, the generating of the purchase benefit information of the shared moving object, which is to be provided to the user device, may be directed to offer a purchase priority to a user within a predetermined period close to the disposal due date during a service period of the moving object.

According to an embodiment of the present disclosure, when the residual value of the user within the predetermined period is equal to or less than a threshold value, the purchase benefit information may be generated by expanding to a user using in the whole service period and is provided to a user device of the expanded user.

According to an embodiment of the present disclosure, the usage may comprise at least one of a distance of use and a number of times of use for the shared moving object, which are aggregated according to each of the user devices, and a ranking of the purchase priority may be given according to the usage.

According to an embodiment of the present disclosure, the method may further comprise allocating preferably to a user interested in purchase, when the computing device receives a request of interest of a user device of a user interested in purchase for the shared moving object before the disposal due date and identifies the user interested in purchase and allocation requests from a multiplicity of user devices compete for the shared moving object.

According to an embodiment of the present disclosure, the method may further comprise providing state information and purchase priority information of the shared moving object via the user device of the user interested in purchase, before the allocating preferably of the shared moving object.

According to another embodiment of the present disclosure, there is provided a server configured to evaluate residual value of a shared moving object and to sell the shared moving object in a fleet system, the server comprising a transceiver configured to transmit and receive a signal and a processor configured to control the transceiver. The processor is configured to generate disposal registration information designating the shared moving object as an item for disposal, when a disposal due date of the shared moving object is imminent, provide market price information of the shared moving object, of which the disposal due date is imminent, analyze usage of the shared moving object according to each user device registered to the fleet system, evaluate residual value of the shared moving object according to the usage of each user device, generate purchase benefit information of the shared moving object, which is to be provided to the user device, according to the usage, transmit the purchase benefit information to be displayed on the user device, and determine purchase price information according to a price based on the residual value.

According to another embodiment of the present disclosure, there is provided a fleet system configured to evaluate residual value of a shared moving object and to sell the shared moving object, the fleet system comprising a server configured to manage the fleet system, a user device registered to the fleet system, and a shared moving object registered to the fleet system. The server is configured to generate disposal registration information designating the shared moving object as an item for disposal, when a disposal due date of the shared moving object is imminent, provide market price information of the shared moving object, of which the disposal due date is imminent, analyze usage of the shared moving object according to each user device registered to the fleet system, evaluate residual value of the shared moving object according to the usage of each user device, generate purchase benefit information of the shared moving object, which is to be provided to the user device, according to the usage, transmit the purchase benefit information to be displayed on the user device, and determine purchase price information according to a price based on the residual value.

According to embodiments of the present disclosure, a method, device and system for disposing of a shared moving object, which is provided in a fleet system implemented by a computing device, by evaluating residual value may be provided.

Also, according to embodiments of the present disclosure, the efficiency of a disposing process of a fleet system may be maximized by generating benefit information for a user device with high usage of a shared moving object, which is differentiated from other user devices, presenting the benefit information as available information and encouraging purchase through the user device receiving the differentiated benefit information.

The technical features of embodiments of the present invention are not limited to the above-mentioned technical features, and other technical features that are not mentioned will be clearly understood by those skilled in the art through the following descriptions.

### BRIEF DESCRIPTION OF THE DRAWINGS

FIG. 1 is a view illustrating that a moving object communicates with another device via a network.

FIG. 2 is a view illustrating that a moving object is shared based on a fleet system.

FIG. 3 is a view illustrating that a user is managed based on a fleet system.

FIG. 4 is a view illustrating an example in which an identification device is applied to a moving object.

FIG. 5 is a view illustrating an example of a fleet system.

FIG. 6 is a flowchart regarding a method of evaluating residual value of a shared moving object according to embodiments of the present disclosure.

FIG. 7A and FIG. 7B are views showing an example of calculating a residual value price of a shared moving object.

FIG. 8A and FIG. 8B are views showing another example of estimating a residual value price of a shared moving object.

FIG. 9 is a flowchart showing a purchase process of a shared moving object according to embodiments of the present disclosure.

FIG. 10 is a flowchart showing an example of a purchase process of a shared moving object according to embodiments of the present disclosure.

FIG. 11 is a flowchart showing another example of a purchase process of a shared moving object according to embodiments of the present disclosure.

FIG. 12A and FIG. 12B are views showing an example of determining a purchaser and a purchase price according to another example of a purchase process.

FIG. 13 is a flowchart showing yet another example of a purchase process of a shared moving object according to embodiments of the present disclosure.

FIG. 14 is a flowchart regarding allocation of a shared moving object to a user interested in purchase according to embodiments of the present disclosure.

FIG. 15A and FIG. 15B are views showing examples of information provided to a user device of a user interested in purchase.

FIG. 16 is a view showing a device configuration according to embodiments of the present disclosure.

### DETAILED DESCRIPTION OF ILLUSTRATIVE EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of embodiments of the present invention and the way of attaining them will become apparent with reference to exemplary embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

Hereinafter, embodiments of the present disclosure will be described with reference to the accompanying drawings.

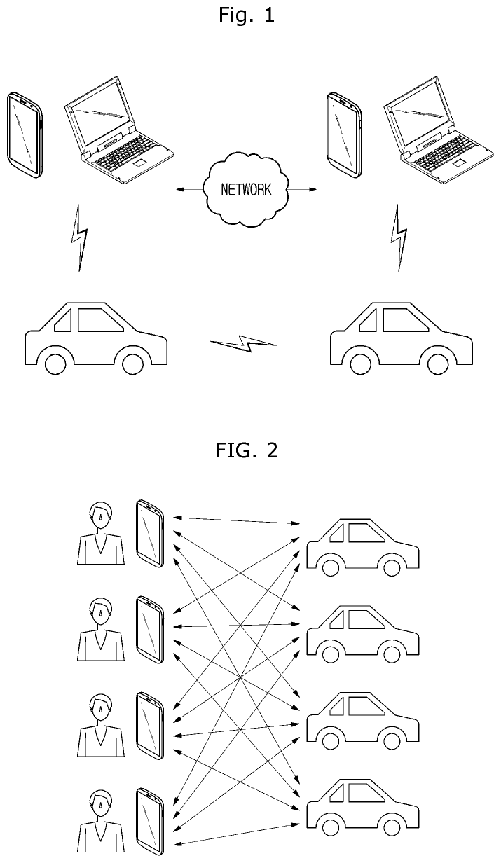

FIG. 1 is a view illustrating that a moving object communicates with another device via a network.

Referring to FIG. 1, a shared moving object may communicate with another moving object or another device. Herein, as an example, the moving object may communicate with another moving object or another device based on cellular communication, WAVE communication, dedicated short range communication (DSRC), or other communication schemes. That is, as a cellular communication network, a communication network such as LTE, 5G, Wi-Fi communication network, WAVE communication network, etc. may be used. In addition, a local area network used in a moving object, such as DSRC, may be used, and the present disclosure is not limited to the above-described embodiment.

In addition, as an example, for the purpose of security of a moving object with respect to communication of the moving object, a module capable of communicating only with a device inside the moving object and a module capable of communicating with a device outside the moving object may exist separately. As an example, inside the moving object, communication based on the security such as Wi-Fi communication may be performed only for a device within a certain range in the moving object. As an example, the moving object and a personal device owned by the moving object driver may include a communication module for performing communication only with each other. That is, the moving object and the personal device of the moving object driver may use a communication network disconnected from an external communication network. Also, as an example, the moving object may include a communication module for performing communication with an external device. In addition, as an example, the above-described module may be implemented as a single module. In other words, based on a single module, a moving object may communicate with another device, which is not limited to the above-described embodiment. That is, in a moving object, communication may be performed based on various methods and is not limited to the above-described embodiment.

Herein, for example, a moving object may refer to a device capable of moving. As an example, a moving object may be a vehicle (including an autonomous vehicle or an automated vehicle), a drone, a personal mobility, a mobile office, a mobile hotel or a personal air vehicle (PAV). “Personal mobility” may include a moving object including at least three wheels for stable independent driving or a moving object (e.g., a single-wheeled segway, a two-wheeled segway, an electric scooter, etc.) that has one or two wheels but is capable of being driven independently by keeping its balance. A personal mobility may use electricity as a power source by means of a battery but is not limited thereto and may utilize any type of power sources capable of moving the mobility. As an example, a personal mobility may mean a means of transportation that may be taken or used by only one user. In addition, a personal mobility may mean a means of transportation that a small number of users may use as a small means of transportation. As an example, not only a single-wheeled segway, a two-wheeled segway and an electric scooter but also an electric wheelchair, an electric bicycle and an electric two-wheeled vehicle may be a personal mobility. In addition, a moving object may be any other moving device and is not limited to the above-described embodiment.

FIG. 2 is a view illustrating that a moving object is shared based on a fleet system.

As an example, a fleet system may be applied to provide a moving object sharing service. Herein, the fleet system may be operated by data generation, processing and exchange between computing devices. For example, a fleet system may be a system including at least one server, a multiplicity of user devices and a multiplicity of moving objects. For a fleet service, a server may process a request of a user device, transmit a response message, and manage a moving object by processing the reservation and allocation/return of the moving object according to the request.

Furthermore, the server may generate status information of every moving object by receiving moving object state information from moving objects so that overall information associated with moving objects may be managed. The server may implement a disposition process of a moving object, of which the disposal due date disposal is near or at hand, through mutual data exchange between a related user device and the moving object by using an application or program embedded in the server. In addition, as an example, the fleet system may further include a road side unit (RSU) and the like. Herein, a device may be a smart phone, a smart pad and a smart watch.

As another example, a device may be a device capable of performing other communication and exchanging a signal, which is not limited to the above-described embodiment. However, for the convenience of explanation, the terms “device” or “user device” will be used in the description below. In addition, as an example, a moving object may be a vehicle. In addition, as an example, a moving object may be an object moving on rails or other constructed areas. As another example, a moving object may be a flying object like drone. That is, a moving object may refer to an object capable of moving and mean a shared moving object based on a fleet system.

For the convenience of explanation, a moving object will refer to a vehicle in the description below. This may be applied to other moving objects in the same way. As another example, a RSU may be a roadside device capable of communication. In addition, as an example, a RSU may refer to a structure installed for transmitting and receiving a signal to and from a building or another area, which is not limited to the above-described embodiment. However, for the convenience of explanation, such structures will be referred to as RSUs in the description below. RSUs may be various structures or devices, which are not limited to the above-described embodiment.

In addition, a fleet system may be a moving object sharing system. For example, a fleet system may be a sharing system of moving objects, which is operated to enable the moving objects to be rented and returned for car sharing in multiple areas dispersed over many regions.

As another example, a fleet system may be a system in which a moving object is shared in a certain area. Herein, the certain area may be a local concept, such as a rental shop, an apartment complex, a work place, and the like. As an example, the certain area may include an area in an apartment complex or an area a predetermined distance around the apartment complex.

As another example, the certain area may mean an area a predetermined distance around the work place. As another example, an area to which a fleet system is applied may be a larger area like an administrative district or a city, which is not limited to the above-described embodiment. That is, the certain area may mean a reference range capable of operation based on a fleet system, and may be changed by a user or a system. In addition, as an example, a fleet system may be a system in which a moving object is shared with a user authenticated as a specific user (or device). As an example, a specific user may be a resident of an apartment in a predetermined range of area or a worker of an office located in a particular region, in which a service of a fleet system may be provided.

As an example, the specific user may be a subscriber to a fleet system available in a predetermined service area and be a user outside the service area. Such a user may be a person who wants to use a sharing service when approaching a predetermined service area. As an example, a fleet system may provide a moving object sharing service based on a device that an apartment inhabitant and/or an office worker has registered. Thus, a sharing service may be provided only to a specific person, and the safety and management efficiency of a moving object may be enhanced. However, a specific user using a shared moving object in a fleet system may be determined based on another method, which is not limited to the above-described embodiment.

In a shared moving object fleet system, a shared moving object may be provided. Here, a shared moving object may be a moving object that has been authenticated and approved to be shared by a system. As an example, the shared moving object may be a moving object registered in the fleet system. Here, a fleet system manager may provide a shared moving object for the fleet system. That is, only a moving object authenticated or authorized by the fleet system manager may be used as a shared moving object. Thus, an accident that could occur due to the safety or management of a moving object in a fleet system may be prevented beforehand.

Specifically, a moving object to be shared may be registered in a fleet system. A right to register a moving object as a shared moving object in a fleet system may be restricted by the fleet system. Herein, a moving object capable of being registered in the fleet system may have a same ID or same identification information. In addition, as a fleet system provides a shared moving object, the management for the shared moving object may be performed. As an example, the management of a shared moving object may be necessary to provide a shared moving object service, such as residual oil information, moving object state information, or moving object driving information for the moving object registered in a fleet system. Herein, the fleet system may check the state of a shared moving object in real time, and for a moving object having a problem, the permission for use may be restricted or a command of repair may be delivered through the system, based on which a service may be provided.

As another example, a fleet system may provide a mixture of a shared moving object and a privately-owned moving object. As an example, the fleet system may set identification information, such as a moving object type indication field, to distinguish a shared moving object provided by the system and a privately-owned moving object. Herein, when the indication field is recorded as a value of a not privately-owned moving object, it may indicate a shared moving object that is not privately owned but is provided by a system provider. On the other hand, when the indication field is recorded as a value indicating a privately-owned moving object, it may indicate there is a moving object privately owned and the moving object is provided as a shared moving object in a fleet system.

It is also possible to consider a case in which a privately-owned moving object and a shared moving object provided by a system are mixed. Herein, as an example, the fleet system may provide different services based on a moving object type indication field. As an example, in the case of a moving object provided by the fleet system, there may be no restriction of use for a user who uses the moving object. On the other hand, in the case of a privately-owned moving object, there may be a restriction of use. As another example, in a fleet system moving object and a privately-owned moving object, a service may be provided based on different charging systems, which is not limited the above-described embodiment.

As another example, in relation to a specific operation of a fleet system, a service may be provided based on a device registered to the fleet system.

Specifically, the device registered to the fleet system may obtain information on a shared moving object after authentication and security procedures with the system. That is, from the perspective of the device, information on the shared moving object may be provided. Herein, the device may contact the moving object to be used based on the information on the shared moving object.

As an example, there may be a moving object and a device (or users) that are registered to a fleet system. That is, based on authentication and authorization that are performed when a user subscribes to a sharing service, only specific moving objects and devices may be registered to the fleet system. Herein, the fleet system may be operated based on state information of the registered moving objects and the registered devices. In case a user temporarily utilizes a sharing service, the user may temporarily subscribe to the sharing service based on a simple authentication procedure, as compared to regular subscription, that is, based on user identification information and device identification information. When the use of the temporary user ends, the sharing service may make the fleet system unavailable to the information of the temporary user. Nevertheless, the fleet system may store the type of a moving object used by the temporary user, period of use, distance of use, a number of times and other history information. In addition, the fleet system may store preference information, rating information and use pattern information, which are generated by a temporary user using a moving object, and refer to such information when the temporary user uses a moving object again or for a service of another subscriber-user.

As an example, the fleet system may check information on a moving object currently in use and location information on an individual moving object in real time. Herein, as an example, each moving object may periodically transmit its information to the fleet system. In addition, as an example, each moving object may transmit its information to the fleet system based on an event trigger. As an example, when an event of a change in location or in whether or not to use is triggered to a moving object, the moving object may transmit its information to the fleet system (or server). In addition, the fleet system (or server) may check information on a registered device in real time.

Herein, as an example, the registered device may not always use a service of the fleet system. Accordingly, activation information indicating whether a registered device uses a service of a fleet system may be needed. Herein, as an example, the fleet system may include list information for a registered device. Among registered devices included in a list of a fleet system, a device, which is currently using a moving object or activates the system to use the moving object may be provided along with list information. As another example, devices may be indicated by being classified into registered devices (deactivated devices) that do not use a fleet system, registered devices (activated devices) that are using a moving object of the fleet system, and registered devices (temporary devices) that are willing to use a moving object. That is, information may be provided as to whether or not actually in use, whether or not there is willingness to use, and whether or not before use although there is willingness to use. In addition, as an example, for a device using a moving object of a fleet system, usage state information may further be indicated. As an example, usage state information may further include information on expected time of use or information on location of use.

Specifically, a fleet system may include list information on a multiplicity of moving objects and a multiplicity of devices that are registered. Herein, the list information may include at least one or more among usage state information, device location information, and moving object location information. Herein, the fleet system may provide a moving object sharing service based on the device location information and the moving object location information. In addition, the above-described usage state information may include at least one or more among information on a moving object in use, information on expected time of the moving object in use, device-moving object matching information, deactivated device information, activated device information, deactivated moving object information, and activated moving object information.

Herein, as an example, the usage state information may further include information on a moving object in use that is being used by another device and information on expected time of the moving object in use. In addition, the usage state information may further include device-moving object matching information based on information in a list form. In addition, the usage state information may include activated device information and deactivated device information. As an example, as described above, the activated device information may be a device that is preparing to use a current moving object among devices registered to a fleet system. As an example, the activated device may mean a device that executes a program or an application for the fleet system. Meanwhile, the deactivated device may be a device that is registered to the fleet system but does not use moving object sharing. As an example, the deactivated device may be a device that does not execute or deactivates a program or application for the fleet system.

In addition, a fleet system may include activated moving object information and deactivated moving object information. In this case, as an example, the fleet system may include state information on a multiplicity of moving objects. Herein, the state information on a moving object may be information on the moving object, such as information on whether or not there is abnormality of the moving object, information on remaining distance to drive, or information on time of refueling. In other words, state information on a moving object may be information for determining whether or not the moving object may be provided for sharing, which is not limited to the above-described embodiment.

Herein, the fleet system may determine whether or not to activate the moving object based on the above-described state information. As an example, for a moving object with no abnormality and a sufficient amount of fuel, the fleet system may provide information as an activated moving object. On the other hand, the fleet system may classify a moving object with an abnormality as a deactivated moving object. Herein, the fleet system may provide information on the deactivated moving object to an associated system or server. As an example, the associated system or server may perform repair or management for a deactivated moving object, which is not limited to the above-described embodiment.

In addition, as an example, a fleet system may classify a moving object with an amount of fuel below a predetermined level as a deactivated moving object, as described above. As another example, when a moving object with an amount of fuel below a predetermined level is shared through a device, the fleet system may provide a device user with information on the amount of fuel through notification. In addition, as an example, the fleet system may provide a user with information on a designated associated system (e.g., a gas station of a specific brand) and provide information indicating the necessity of refueling. Herein, the fleet system may exchange charging information or other necessary information with a designated associated system regardless of the user, thereby providing a service.

That is, a user using a moving object sharing system may refuel the moving object at a designated place without paying a fee, and the fee may be processed through the fleet system and an associated system. Meanwhile, as an example, as described above, a user of a device (temporary device) willing to use a moving object may want to use the moving object by checking a fleet system.

As an example, a moving object to be used may be allocated to a device through a fleet system. Herein, as an example, the fleet system or server may allocate the moving object to the device by using at least one of information on the moving object in use, location information of the moving object, and location information of the device. Meanwhile, as an example, when the fleet system cannot allocate any moving object, the fleet system may provide the device with information on the failure. In addition, as an example, the fleet system may allocate only a moving object within a predetermined distance from the location of the device, which is not limited to the above-described embodiment. Next, the device may come within the predetermined distance from the moving object. Here, the device may transmit an authentication signal to the moving object. In addition, as an example, the device may use a shared moving object by tagging the shared moving object based on a list of available moving objects. As an example, the device may tag a moving object based on NFC, Bluetooth, or a magnetic means like a transportation card. Herein, when the device tags a shared moving object, an authentication procedure from the fleet system may be performed to provide the moving object to the device. As an example, when the authentication is completed based on the device tagging, the door of the moving object may be opened.

As for a detailed operation for authentication, when a device approaches a moving object within a predetermined distance, an authentication signal may be transmitted to the moving object. Herein, communication available to the moving object and the device may be Bluetooth, NFC or tag, as described above. That is, a procedure for authentication may be performed under certain conditions, which is not limited to the above-described embodiment. When the device approaches or tags the moving object, the moving object and the device may exchange a signal so that whether or not the device may use the moving object is determined and the device is authenticated. Herein, the device may transmit, to the moving object, an authentication signal including its identification information and identification information of a group in which the device is included. Here, based on the identification information of the device included in the authentication signal thus received, the moving object may verify whether or not the device is registered to a fleet system. In addition, based on the identification information of a group included in an authentication signal, a moving object may confirm whether or not the device is included in a group to which the moving object may provide a service. In other words, based on device identification information and group identification information, a moving object may determine whether or not a device may use the moving object. As an example, when the device is incapable of using the moving object, the moving object may transmit information on unavailability to the device. As an example, the device may obtain the information on unavailability from an application or another service providing program.

Meanwhile, when the device is capable of using the moving object, the moving object may transmit a signal requesting the execution of an authentication procedure to the device. That is, when the device is legally registered to the above-described fleet system (or server) and the moving object is capable of operating legally based on the fleet system, the moving object may transmit the signal requesting the execution of the authentication procedure to the device. Herein, the moving object may include its own identification information and encryption key information in a signal for requesting the execution of an authentication procedure and transmit the signal to the device. As an example, both the moving object identification information and the device information may be registered to the fleet system. In this case, the moving object may transmit a signal including the moving object identification information, the device identification information, and the encryption key information to the fleet system.

In addition, the device may also transmit a signal including identification information of a moving object, encryption key information, and its own identification information, which are included in a signal requesting the execution of an authentication procedure, to the fleet system.

Then, the fleet system may compare information included in the signal received from the moving object and information included in the signal received from the device. Herein, when the moving object identification information, the device identification information, and the encryption key information all agree, the fleet system may recognize that the device is capable of using the moving object. Then, the fleet system may transmit authentication confirmation information to the moving object and the device. Herein, the fleet system may register, to a database, information indicating that the device uses the moving object. In addition, as an example, time for the device to use the moving object and additional information may be continuously transmitted.

In addition, the moving object may register the device based on the authentication confirmation information and may open the door of the moving object. In addition, a lock may be released to use the moving object, whereby the device may control the moving object.

Herein, as an example, when the above-described authentication is completed, the moving object and the device may periodically exchange signals. That is, while the device uses the moving object, the moving object may continuously confirm the use by periodically exchanging signals with the device.

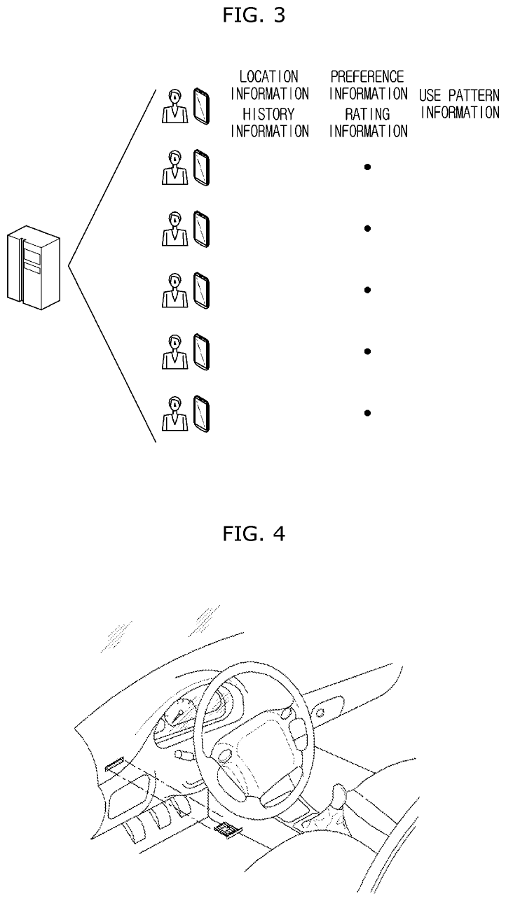

FIG. 3 is a view illustrating that a user is managed based on a fleet system.

For example, based on the above description, a moving object and a device may be managed in a fleet system. Herein, as an example, information of each user may be managed in the fleet system. As an example, information of each user may be information on the user's use based on the user identification ID or the user's identification device. As a more concrete example, information of each user may include at least one or more among information on the user's location, information on the user's history, information on the user's preference, information on use status, rating information, and use pattern information. As an example, information on the user's location may be information for identifying the user's main route while using a fleet system. As an example, a user's location information may be static location information set by the user like the user's residence and place of work and dynamic location information like location information at time of use request and location information at expected time of use. In addition, as an example, a fleet system may store history information of a user.

History information may be information on a user's propensity, which is analyzed based on a type of a moving object used by a user, a use zone provided to a fleet system, a travel route, a destination point, and a parking point during use. As an example, a fleet system may perform a recommendation for the use of a moving object based on a user's history information. In addition, history information may include usage accumulated in each moving object used by a user. Usage may include at least one of distance of use, a use period, and the number of times of using a moving object. The number of times of using a moving object may be counted and recorded in each section over a whole service period in which a sharing service is provided. For each moving object, a user's usage may be stored and managed in a server of a fleet system or in the moving object.

As an example, a fleet system may perform management for allocating and distributing a moving object by using history information of a multiplicity of users.

In addition, as an example, a fleet system may include information on a user's preference. As an example, information on a user's preference may be information considering the frequency or preference of a moving object in use. Specifically, preference information may be a type of the moving object that is designated or estimated by the user as a preferred moving object. In addition, as an example, a user's preference information may be information input by the user, which is not limited to the above-described embodiment.

In addition, as an example, a fleet system may provide rating information of a user. Rating information may be rating levels given to each user based on use state information including subscription information for a fleet system and use performance information and after-use evaluation information. As an example, subscription information may be information on whether or not a long-term contract is made as a contract condition for a service of a fleet system and whether or not premium membership is signed up. Use performance information may include a frequency with which a user uses a moving object, a fee according to time or distance, and the like. As an example, when a user frequently uses a moving object, the rating may be raised. In addition, in relation to evaluation information, a rating level may be lowered when a user smokes or causes a bad smell in a moving object and a subsequent user or a manager makes a comment of poor use or such a comment is accumulated. In addition, in relation to evaluation information, a rating level may be raised when a moving object is used without an accident or in a continuously good condition so that no unnecessary maintenance work is needed.

In addition, a fleet system may provide information on a user's use pattern. Use pattern information may be generated by collecting at least one of life pattern information and riding pattern information for each user. As an example, life pattern information may be generated based on at least one of a user's consumption information, a destination point of a moving object during past use, and a waypoint of the moving object during past use. Riding pattern information, for example, may be configured based on at least one among a usage zone and a parking space of a moving object, an average number of passengers of the moving object, the age and sex of a passenger, and a passenger's body information. By considering use pattern information, a fleet system may determine at least one zone suitable for a user in a large fleet parking lot and may allocate a moving object placed in the zone. In addition, by analyzing use pattern information, a fleet system may determine a zone of a fleet parking lot for return and an optimal parking space according to a user's use pattern and may notify when reserving a moving object.

That is, a fleet system may match a moving object to a user based on various information related to the user. In addition, a fleet system may manage a user based on user-related information.

As an example, the above-described various information may be stored in a server controlling a fleet system and be managed. As another example, at least some of the above-described information may be installed in a moving object or be stored in an identification device capable of tagging or in a user device capable of communicating in a system and a moving object. When a moving object is allocated and used by a user, an identification device may be utilized to identify and authenticate whether or not the user is a user making a reservation. An identification device may transmit data for controlling a moving object, apart from for authentication, to the moving object and a fleet system (server). For example, by storing rating information of a user, an identification device may apply a benefit and penalty according to a rating level of the user to the control of a moving object.

In addition, an identification device may detect a user's poor use through a sensor installed in a moving object, store evaluation information determined in real time, and transmit the information to a server. The server may update evaluation information. In addition, an identification device may collect life pattern information like the real-time travel path, destination point, and waypoint of a moving object in real time and transmit the information to a server so that the server may update life pattern information or change a return zone and a parking space that are designated at the time of reservation. In addition, an identification device may obtain riding pattern information different from the time of reservation in real time and transmit the information to a server so that the server may update riding pattern information or change and control a zone of return and a parking space, which were designated at the time of reservation.

An identification device or a user device may store usage of each moving object used by a user and transmit the usage to a fleet system (server).

The shape of the above-described identification device is illustrated in FIG. 4. FIG. 4 is a view illustrating an example in which an identification device is applied to a moving object.

The identification device may be a device having at least any one or more functions of identifying a user, a control target, and a service target. In addition, as an example, the identification device may be a device having an ID function. In addition, the identification device may be at least any one or more among a smart device, a smart module, a user identification module, and an identification module. That is, the identification device may be a hardware configuration. In addition, the identification device may be a software configuration used for the above-described identification. Herein, as an example, the identification device may be a subscriber identity module (SIM). As an example, a SIM, which is applied as an identification device to a moving object, may be at least one or more of a mobility SIM (M-SIM) and a vehicle SIM (V-SIM). In addition, as an example, the identification device may be a module that is the same as or compatible with an existing SIM, which is not limited to the above-described embodiment.

As described above, an identification device may be applied to a moving object by considering such a case in which the moving object performs communication with an external device. As an example, a user may be recognized through a universal subscriber identity module (USIM) in a user's device phone, and a service may be provided. Based on what is described above, a moving object may also have an embedded identification device card. As an example, as an identification device applied to a moving object, a vehicle SIM may be referred to as VSIM. That is, as an identification device applied to a moving object, a new type of identification device may be applied. As an example, a VSIM may be compatible with a USIM or another SIM. In addition, a VSIM may provide another service by considering a characteristic of a moving object, which is not limited to the above-described embodiment.

As in FIG. 4, there may be a part in a moving object, to which an identification device is applicable. Herein, FIG. 4 is merely an example to which an identification device is applied, and the present invention is not limited to the above-described embodiment. Specifically, as shown in FIG. 4, a part for applying an identification device may exist in a position visually identifiable at the driver's seat of a moving object. Although not illustrated herein, as another example, the identification device may be applied inside the glove compartment of a passenger seat in a moving object. As another example, an identification device may be inserted into a part where a display of a moving object is present, which is not limited to the above-described embodiment, and there may be a slot capable of holding an identification device in a suitable part inside and outside a moving object. As another example, in consideration of the portability of an identification device, the identification device may be embodied in a combined state with a tool key or a car key. That is, an identification device may be installed in a tool key or a car key, and the identification device may be removed from the car key and be used by being installed in a moving object. A tool key or a car key may communicate with a moving object via a local area network (e.g., Bluetooth, Beacon, NFC) and thus perform message exchange and identification. That is, a car key or a tool key reflecting the uniqueness of an individual may be used as an identification device, which is not limited to the above-described embodiment.

As another example, the above-described identification device may be installed through an existing device, which is installed in a moving object. As an example, an existing device (e.g., toll payment terminal, black box) may be installed in a moving object. As another example, an identification device may be recognized through an existing terminal (e.g., USB port, cigar jack socket) included in a moving object.

As another example, an identification device may be applied to any position in a moving object within a range capable of authentication, and the identification device may be applied either as an integrated form or a separate form to a control unit, a communication unit or constitutional parts of the moving object.

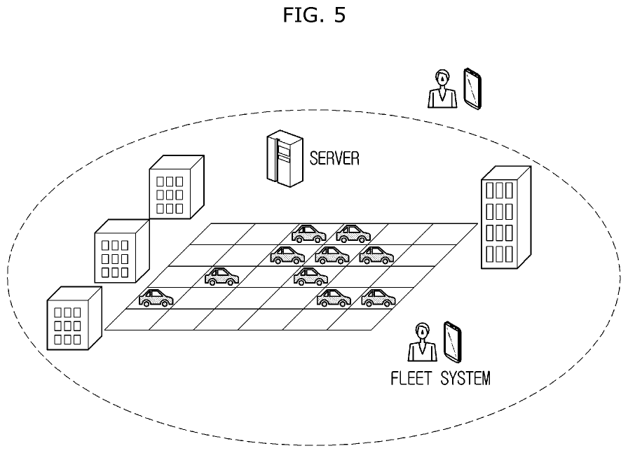

FIG. 5 is a view showing an example of fleet system according to an embodiment of the present disclosure.

A fleet system may have and operate a fleet space in which a shared moving object may be allocated and returned. A fleet space may be a region in which a shared moving object is kept and a service is provided in a predetermined area. As an example, the predetermined area may be located as an area near a region dense with residential districts and/or commercial districts. This aims to enable a fleet system to enhance the convenience of a service for persons using buildings near residential and/or commercial buildings holding many people or a large floating population. People who are likely to use a fleet system include not only inhabitants of buildings but also other people using the fleet system for various purposes like visiting a neighboring area of a fleet space or transferring to another moving object via the fleet space.

A fleet system according to embodiments of the present disclosure may be operated by a small number of moving objects and be operated also by a large number of moving objects for expanding services and ensuring convenience through the fleet system. When being operated by a large number of moving objects, a fleet space may have a large area of space for holding various types of many moving objects. When a fleet space is operated as a large area of space, a lot of moving objects may be deployed to be held uniformly across the large space and be deployed by considering a building around the fleet space, the number of residents, a floating population, and the like. Accordingly, a fleet space may be divided into a multiplicity of zones in order to efficiently manage many moving objects. A holding area and a parking space may be allocated to a zone by considering information of the neighboring area of the zone such as a building around a fleet spot, the number of residents, a floating population, and the like.

As another example, a maintenance or check-up zone may be allocated among zones of a fleet space. For example, a fleet system may instruct a user of a moving object to return the moving object not to an original return zone but to a maintenance zone, when the moving object to be returned has no reservation for a predetermined time and the fleet system determines the need of check-up for the moving object or the need of urgent maintenance based on the state information of the moving object, even if there is a subsequent reservation. As another example, when a fleet system determines the need of check-up for a moving object not in use but parked in a non-maintenance zone, the fleet system may move the moving object to a predesignated zone in an unmanned or manned manner. Herein, the predesignated zone may be a place of maintaining and managing a moving object such as a garage, a car wash and a cleaning service for the interior of a moving object.

As another example, a fleet system may manage moving objects by grouping the moving objects in units of a predetermined number. In addition, the fleet system may perform maintenance and management for each group of moving objects. In the above-described example, when a maintenance zone is a garage, a car wash and the like, a designated zone (a garage, a car wash and a cleaning service for the interior of a moving object) for maintaining and managing moving objects may be set for each group of moving objects. That is, when the maintenance and management for a moving object is necessary, a fleet system may move the moving object to a designated zone of each group in a manned or unmanned manner, thereby enabling the moving object to be maintained and managed. As the maintenance and management for moving objects is performed in each group of moving objects, as many moving objects as possible may be maintained and managed in a limited time.

As another example, a fleet system may enable a moving object to be quickly maintained and inspected during an inspection time by placing a support unit for maintaining and managing moving objects in each group of moving objects. For example, the support unit may be a maintenance vehicle placed for maintaining and managing moving objects.

As an example, a fleet system may be operated so that a central server manages moving object state information related to the allocation/return state, location and use state of a moving object, and re-allocation of a zone of a moving object for a multiplicity of zones and processes each type of the user information described above. As another example, a fleet system may be operated in a distributed way so that a slave system for each zone is allocated to process and manage a task related to the moving object and a central master server accepts a user's use request and manages a task until the allocation of a moving object in a specific zone and various information of each user. A master server may receive a processing result of a task related to a moving object and update information of each user. Hereinafter, for the convenience of explanation, a central server will be described to process a moving object and information of each user and to manage every zone, but it is not excluded that such processing is performed in a master server and a slave system.

In principle, a fleet system is operated to rent a moving object in a fleet space and to return the moving object to a corresponding zone and may also be flexibly operated to return the moving object to another space different from the corresponding space according to rating information of each user and use pattern information. In addition, a fleet system may permit return to a different type of fleet system by considering a type of premium service used by a user, a temporary request and rating information.

Zones of a fleet space may be provided on the ground surface or may be set as a multiplicity of zones for each floor of multi-story buildings and facilities in order to enhance the availability of ground surface.

Hereinafter, a fleet system implemented by a computing device will be described to evaluate differentially a residual value of a moving object according to each user device and to determine a price calculated based on the residual value as purchase price information.

A fleet system has an embedded application or program for evaluating residual value and determining purchase price information. For the convenience of explanation, such applications and programs will be collectively referred to as applications. An application may implement an evaluation and determination process based on requests and data mutually transmitted among a user device, a shared moving object and a server. Such an application may be embedded in a user device, a shared moving object and a server so that the server may implement the process by obtaining information generated from each computing device. For the convenience of explanation, it is mainly described that a server executes the process. However, for example, in order to secure a storage space of a server memory, usage of a moving object may be accumulated in a user device and/or a shared moving object, and the usage thus accumulated until the time of request may be transmitted to the server at the request of the server.

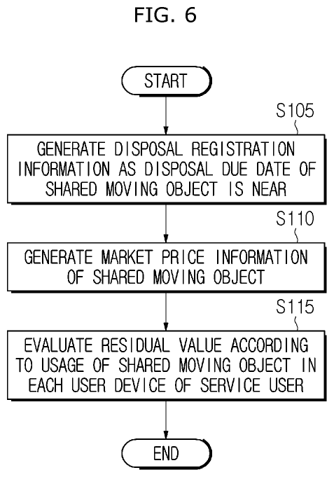

FIG. 6 is a flowchart regarding a method of evaluating the residual value of a shared moving object according to embodiments of the present disclosure.

First, when a shared moving object's disposal due date is near, a fleet system (or server) may generate disposal registration information that designates the shared moving object as an item for disposal (S105).

The disposal due date of a shared moving object may be determined according to model year, mileage, state, users' preference, release of a new moving object in the same category, and ease of change of parts.

A moving object state may be related to whether or not the moving object will undergo deterioration of performance in a predetermined period, although capable of being driven now. Even when age and mileage are lower than a predetermined value, if it is determined that the performance of a moving object will deteriorate and become unsuitable for being utilized for the fleet system, the server may determine that the disposal due date is near.

Based on preference information of a multiplicity of users, the users' preference may be related to whether or not the reservation rate of a shared moving object is constantly low. Even when moving objects are in a good state, the fleet system may determine that a moving object with a low level of users' preference will be sold in order to ensure efficiency of operation and cost. In addition, when a new model of an existing moving object is released, users' preference is expected to be lowered so that sale of the existing moving object may be determined. That is, even when the disposal due date has not arrived with respect to other factors, if users' preference is lowered, the disposal due date may be determined ahead of expectation.

Next, the fleet system (or server) may provide current market price information of a shared moving object of which the disposal due date is near (Silo).

The current market price information may be determined based on a maker of the moving object, a model name, a total distance of use, model year, fuel efficiency, accident history, options, moving object state, and actual statistics of resale value.

The state of a moving object may include not only essential elements for driving like a power system and a brake system but also non-essential elements like exterior scratches, change of color, interior smell, and cleanliness of moving object interior.

Next, the fleet system (or server) may analyze usage of a shared moving object according to each user device of the fleet system (or sharing service) by referring to current market price information and may evaluate residual value of the shared moving object according to the usage in each user device (S115).

As a user device is a device that may be possessed not only by a user of the shared moving object but also by a non-user and a non-subscriber not registered in the fleet system, for the purpose of clear understanding of an embodiment, terms “user”, “non-user” and “non-subscriber” may be used in the description, as necessary. However, these terms are commonly referred to from the human viewpoint and mean processing by a user device and information that is generated or transmitted by the user device.

Describing the step S115, the server may analyze usage based on at least one of the use distance, use period and use times of a shared moving object according to each user device. Usage is generally proportional to a distance of use, but even a short distance of use may be accompanied by an increase of use period and use times because of frequent use. Herein, the use period may include not only units of days but also a total time of actual use. As frequent use indicates that a user has high preference for a moving object, the server may estimate that the user's probability of purchasing the moving object is high. Accordingly, use period and times may be considered. In case usage is calculated using at least two of distance of use, use period, and use times, each factor may be weighted. The description below shows an example of calculating usage based on distance of use, but usage may also be calculated based on a multiplicity of factors in a similar method to what will be described below.

Considering that a user is registered to the fleet system and uses a specific moving object, in order to attract the user to purchase the shared moving object, the fleet system (or server) may determine that the user's residual value is to be calculated lower than the market price information of the shared moving object, and each user may be differently evaluated. As will be described below, in order to generate differentiated purchase benefit information for the user, the residual value of a non-subscriber of the service may be the same as the market price information.

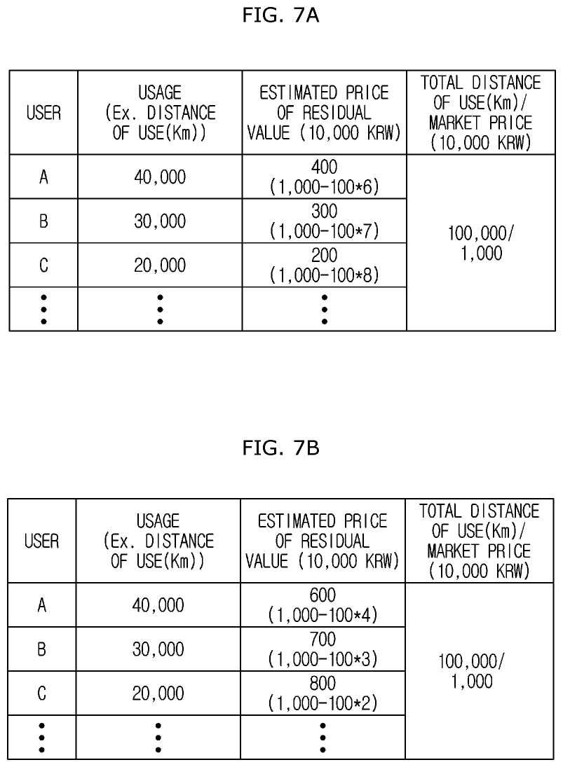

Referring to FIG. 7A and FIG. 7B, calculating a residual value of a shared moving object for each user according to usage based on distance of use will be described. FIG. 7A and FIG. 7B are views showing an example of calculating a residual value price of a shared moving object.

Since a user with high usage is estimated to have a high possibility of purchase, FIG. 7A illustrates an example of calculating a residual value in proportion to usage.

For example, the fleet system (or server) may set an evaluation factor (e.g., 6, 7 and 8 included in an estimated price of residual value) for determining a deduction subtracted from a market price to increase along with an increase in distance of use. Accordingly, since a user A obtaining a longest distance of use has a lower evaluation factor than another user, the user A's estimated price of residual value for a shared moving object may be evaluated to be higher than another user.

As another example, in order to give a user with high usage an advantage in purchase, FIG. 7B illustrates calculation of residual value that decreases according to usage.

For example, an evaluation factor (e.g., 2, 3, and 4 included in an estimated price of residual value) for determining a deduction subtracted from a market price may be set to increase along with an increase in distance of use. Accordingly, since a user A obtaining a longest distance of use has a higher evaluation factor than another user, the user A's estimated price of residual value for a shared moving object may be evaluated to be lower than another user.

FIG. 7A and FIG. 7B illustrate evaluation factors to be subtracted from a market price but are not limited thereto. It is possible to apply various methods for calculating each user's residual value that decreases or increases according to distance of use.

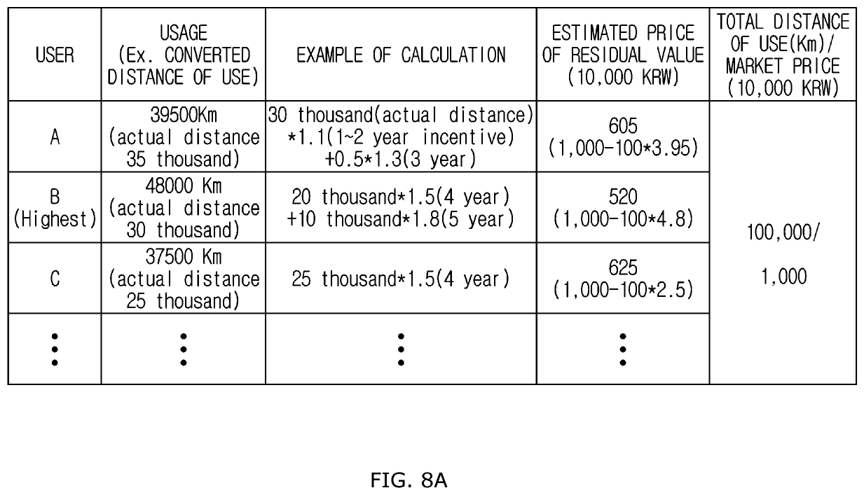

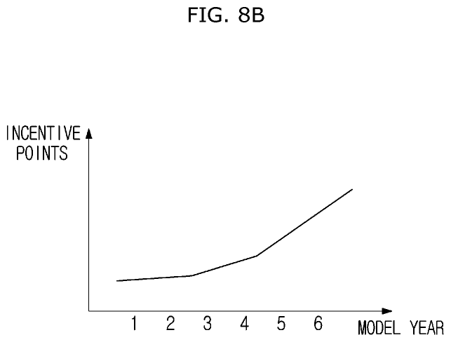

In the above embodiment, residual value is evaluated for an entire service period from a moment when a shared moving object is provided to a fleet system first to its disposal due date only based on distance of use, while another embodiment according to FIG. 8A and FIG. 8B shows an example of evaluating residual value by considering the fact that a shared moving object is not easy to sell as its life cycle of usage passes.

FIG. 8A and FIG. 8B are views showing another example of estimating residual value price of a shared moving object. In FIG. 8A and FIG. 8B, usage utilized to evaluate the residual value may be analyzed, for example, not only by depending on a user's actual mileage but also by utilizing a distance of use that is converted from mileage of each section over a use period according to a predetermined method.

Specifically, referring to the example of FIG. 8A, the actual mileage of the user “A” over the entire service period is 35,000 Km, and the user A has the highest usage according to the actual mileage. When applying the extra points of FIG. 8B to a time near a disposal due date in which a user's preference and the merit of sale are reduced, a user with a longest distance of use may be different.

Referring to FIG. 8B, a weight applied to a converted distance of use may be set to increase as the life cycle of a moving object passes, and a change rate may be set to be different according to each section of the life cycle. For example, the weight may also be set to be higher in a section with a high change rate than in a section with a low change rate. As a different example from FIG. 8B, when preference for a moving object rather increases or is maintained as life cycle passes and a market price rises or is actually maintained in a second-hand market from a certain point to a disposal due date, a weight according to the life cycle may be adjusted according to the preference and the market price.

As another example, a weight and a change rate may be different according to each shared moving object. First, a weight and a change rate may be determined according to the maker, type, mode and option of a shared moving object. Furthermore, even when moving objects have a same model, a weight and a change rate for individual shared moving objects may be differently determined according to moving object condition and accident history.

Referring to FIG. 8A again, a fleet system may divide a user's actual mileage according to each section of a whole service period, which is designated by the fleet system, produce a converted distance for each section by applying a weight (an incentive extra point) of each section to the actual mileage, and calculate a converted distance of use by aggregating converted distances of each section. The converted distance of use may be considered as usage.

In this way, as the user B used a shared moving object actually with less mileage than the user A but utilized the shared moving object mainly in a section close to a disposal due date, a high weight is applied to the user B and a maximum converted distance of use may be calculated for the user B rather than the other users.

Based on such a converted distance of use, a fleet system may evaluate residual value according to each user. The residual value evaluation of FIG. 8A was performed like FIG. 7B but may also proceed in the method of FIG. 7A. In an embodiment of the present disclosure, usage calculation based on a use period is described which applies a weight to a distance of use according to the use period. As another example, usage may be calculated in a similar method to FIG. 8A by including a number of use times as a factor, to which a weight is applied, for each section of a service period. As yet another example, after a distance of use, a use period and a number of use times are aggregated respectively for each section of a service period, usage may be calculated by applying a weight of each section to an aggregate distance, an aggregate period, and an aggregate number of times respectively.

Embodiments of the present disclosure include a process of determining a purchase and a purchase price according to a price based on the above-described residual value, which will be described below.

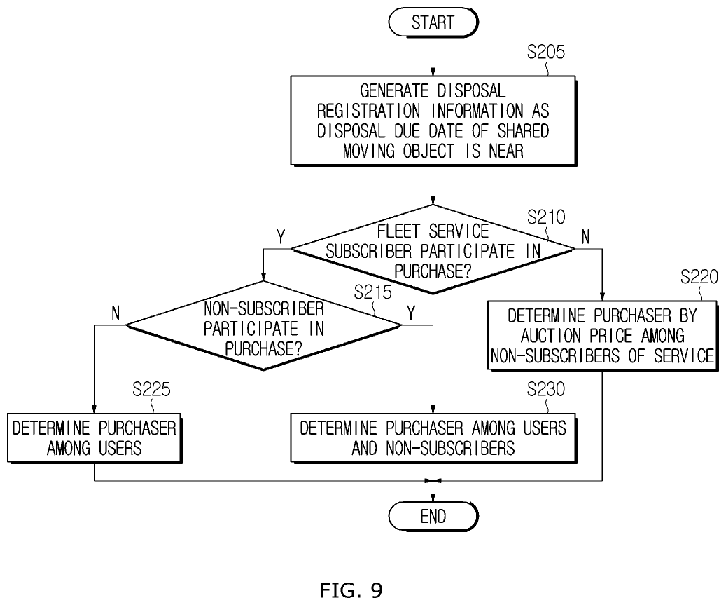

FIG. 9 is a flowchart showing a purchase process of a shared moving object according to embodiments of the present disclosure.

First, a fleet system may check the imminence of a disposal due date of a shared moving object and generate disposal registration information of the shared moving object (S205).

Based on the disposal registration information, the fleet system may send a sales plan message of the shared moving object, of which the purchase is encouraged through users' devices. The notice may be delivered to all the devices of the service subscribers or may be selectively delivered to a device of a user of the moving object to be sold. The notice thus delivered to a user of the moving object may include not only the fact of the sales plan but also information on the moving object such as a total distance of use, model year, fuel efficiency, accident history, moving object state and other various information like the user's estimated price of residual value and an expected purchase ranking according to the estimated price.

The notification may be delivered to a non-subscriber of the service via an application of the fleet system, its secondhand moving objects platform or an external platform linked to the fleet system. The above-described information of the moving object may be provided to a device of a non-subscriber of the service.

Next, the fleet system may set up a disposing process of a shared moving object by driving a sales application included in an application of the system, register a purchase participant through the sales application, and check whether or not a service subscriber participates in the purchase (S210).

Purchase participants may include a past user of a moving object to be sold, a non-user subscribing to the service, and a non-subscriber of the service. A device of a purchase participant may access the disposing process by means of the sales application.

In case no service subscriber participates in the purchase (N of S210), the fleet system may determine a purchase and a purchase price through an auction among non-subscribers (S220). In case service subscribers participate in the purchase (Y of S210), the fleet system may proceed with the purchase by another process.

As for the another process, the fleet system may implement separate processes for a case in which only users of the moving object are registered and for a case in which both users and non-subscribers are registered together (mixedly), respectively. In addition, when a non-user of the moving object is registered together with at least one of a user and a non-subscriber, the fleet system may proceed an actually same process as the process for the case of mixed registration.

Accordingly, when the fleet system determines that purchase participants include neither a non-subscriber nor a non-user (N of S215), the fleet system may proceed with a process of determining a purchaser among users (S225). When the fleet system determines that purchase participants include a non-subscriber (Y of S215), the fleet system may proceed with a process of determining a purchaser among users and non-subscribers (S230).

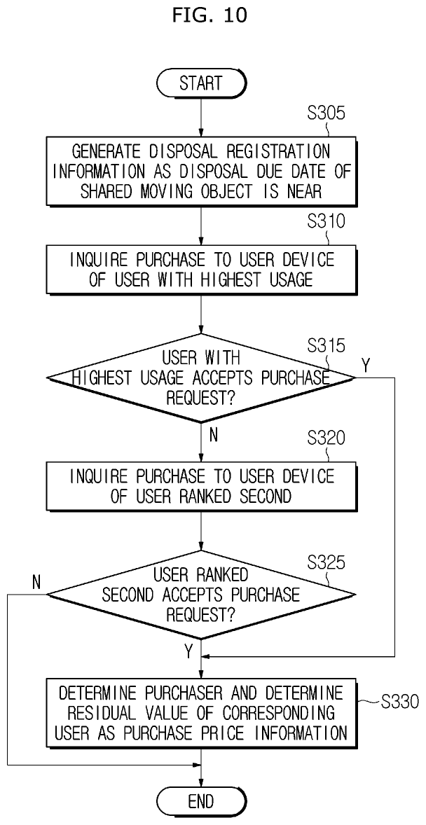

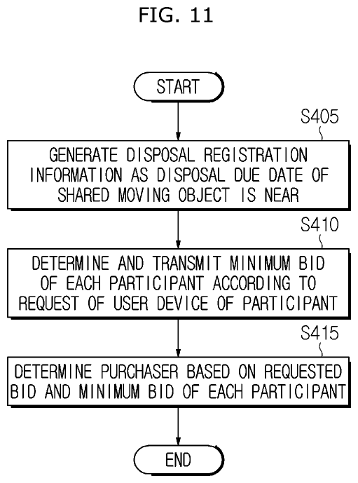

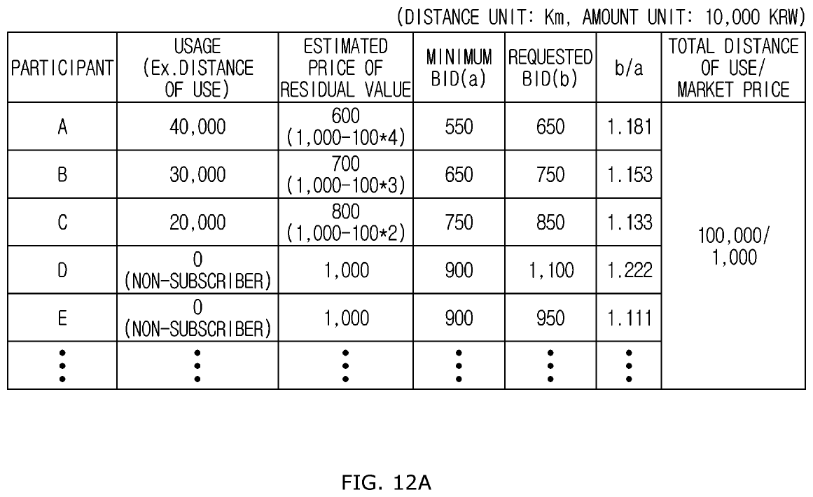

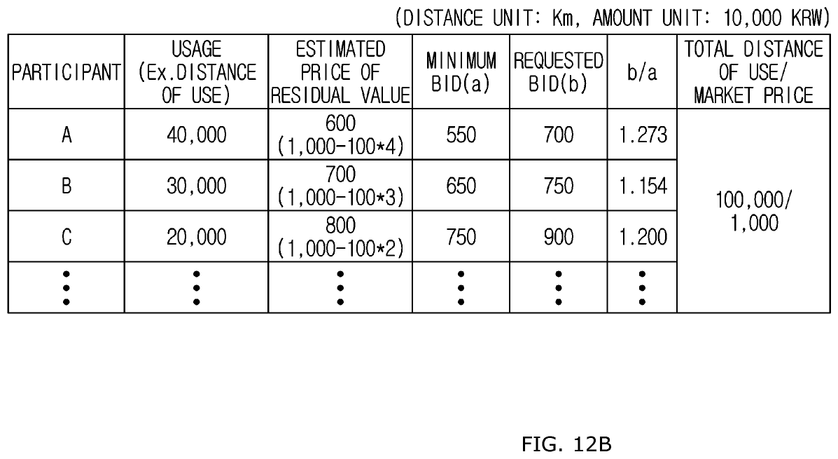

A purchase process only for users may be any one of determining a purchaser by purchase priority benefit and determining a purchaser by an auction. The process according to the purchase priority benefit is illustrated in FIG. 10, and an auction process is illustrated in FIG. 11 and FIG. 12.

Referring to FIG. 10, the purchase process according to purchase priority benefit will be described. FIG. 10 is a flowchart showing an example of a purchase process of a shared moving object according to embodiments of the present disclosure.

First, when a disposal due date of a shared moving object is near and disposal registration information is generated (S305), a fleet system may generate a purchase priority right, which asks first a user with highest usage identified from FIGS. 7A to 8A to purchase, as benefit information, and may transmit the purchase priority right to a corresponding device (S310).

When asking to purchase, the fleet system may generate purchasable price information based on an estimated price of residual value according to FIGS. 7A to 8A and transmit the purchasable price information to be displayed on the device. The purchasable price information may be the same as the estimated price of residual value or be an amount that is calculated for the estimated price in a predetermined method.

Information on the moving object, for example, a moving object state, accident history, and statistics of actual secondhand sales prices, may be transmitted to the user with highest usage, together with the purchase inquiry. In addition, in order to encourage a purchase, information on the rankings of users (including the user with highest usage) and purchasable prices may be provided to the user with highest usage. The rankings and purchasable prices of the other users (excluding the user with highest usage) may be provided to a user with low priority, who is willing to participate in the purchase but to whom the purchase inquiry is not transmitted.

Next, the fleet system may check whether or not the user with highest usage accepts the purchase or transmits a request message (S315).

A predetermined period is given to the user with highest usage, and the user registers, during the period, a response as to whether or not to purchase. As another example, in case there is no response, during the period, as to whether or not to purchase, the fleet system may determine finally that the user with highest usage does not want to purchase.

As a checking result, in case the user with highest usage accepts the purchase request (Y of S315), the fleet system may confirm the user with highest usage as a purchaser and determine a purchasable price, which is presented to the user with highest usage, as final purchase price information (S330).

On the other hand, in case the user with highest usage does not accept the purchase request (N of S315), the fleet system may generate a purchase right, which requests a user securing second-top usage in FIGS. 7A to 8A to purchase, and transmit the purchase right to a device (S320). As described above, a purchase request may be transmitted to display purchasable price information and information on the moving object on the device.

Subsequently, the fleet system may check whether or not there is a purchase acceptance request of a user ranked second like in the case of the user with highest usage. In case the acceptance request is present, the user ranked second and a corresponding purchasable price may be determined as a final purchaser and purchase price information. In case there is no acceptance request, the same purchase inquiry, confirmation of acceptance and determination of purchase as in the above-described step may be performed for a user ranked next.

In an embodiment according to the present disclosure, no limitation on the number of users, to whom the purchase inquiry is sent, has been described, but the above-described process may be performed until a predetermined ranking of usage for efficiency of the disposing process. As another example, the fleet system may perform the above-described process for a group of highest rankings, and when all the users of the group refuse purchase, the fleet system may perform the process for a group of next highest rankings. As yet another example, for more efficient operation, the fleet system may perform the above-described process only for the group of highest rankings, and in case there is no purchaser, the fleet system may send a purchase inquiry simultaneously to the users of a group of next highest rankings so that a purchaser sending a quick response of purchase acceptance may be determined as a final purchaser. In this case, since the purchasable price of a user of the group of next highest rankings may be considerably high, the fleet system may lower the purchasable price and provide the lowered purchasable price to the user or present a same purchasable price to the user. Considering balance with the group of highest rankings, a lower or same purchasable price may be determined based on a price of a user ranked lowest in the group of highest rankings.

According to an embodiment of the present disclosure, a purchase inquiry is sent first to a user with high usage, and residual value of a shared moving object is evaluated in favor of the user with high usage. As the residual value is reflected in a purchasable price, better benefits may be provided to the user with high usage. In addition, as the benefits are conferred to a user with high possibility of purchase, an operator of the fleet system may dispose of the moving object in a short time.

Referring to FIGS. 11 to 12B, an auction process will be described as another embodiment of the present disclosure.

FIG. 11 is a flowchart showing another example of purchase process of a shared moving object according to embodiments of the present disclosure, and FIG. 12A and FIG. 12B are views showing an example of determining a purchaser and a purchase price according to another example of the purchase process.

First, like in the step S205 of FIG. 9, a fleet system may generate disposal registration information of a moving object and register purchase participation, when a disposal due date of the moving object is near (S405). In case a user and a non-subscriber of service are mixed as purchase participants, the fleet system may perform an auction process.

The fleet system may generate a minimum bid based on an estimated price of residual value according to FIG. 12A as benefit information and transmit the minimum bid to the devices of all the purchase participants in such a way as displaying it (S410). The minimum bid may be the same as the estimated price of residual value or be an amount that is calculated for the estimated price in a predetermined method. For example, in the case of a user, an estimated price of residual value may be calculated like in FIGS. 5A to 6B, and in the case of a non-subscriber, in order to offer a purchase benefit to the user, an estimated price of residual value may be calculated to be lower than a market price but higher than the user's estimated price and may be determined depending on a state of a moving object. In addition, a minimum bid of a user may be differentially determined according to usage and be set to decrease, for example, along with an increase of usage.

The fleet system may transmit information of a corresponding moving object together with the minimum bid so that they may be displayed on a device. In addition, in order to encourage purchase, the rankings of all the purchase participants and the minimum bid may be transmitted to every participant.

Next, the fleet system may receive requested bids from participants and determine a purchaser and purchase price information based on a requested bid of each participant and the minimum bid (S415).

The fleet system may receive requested bids from participants for a predetermined period and provide the requested bids thus received and expected rankings of purchase via user devices of the participants. Although having input a requested bid, a participant may change the requested bid by referring to other participants' requested bids.

The fleet system may determine a purchaser when requested bids are finally registered. In the example of FIG. 12A, when participants' requested bids are simply compared, the participant D has the highest requested bid. In this case, an existing user may have no favorable benefit in purchasing a shared moving object. Accordingly, a user's usage may be considered to determine a purchaser. For example, the fleet system may determine a participant, who has a highest ratio (b/a) of a minimum bid reflecting usage and a requested bid, as a purchaser. This embodiment shows an example of determining a purchase according to a ratio between a minimum bid and a requested bid but is not limited thereto, and various types of determination processes including a factor considering usage may be applied as long as they offer a purchase benefit to a user of a shared moving object.

In FIG. 12A, as the user C registers a requested bid based on a benefit of usage, that is, based on a minimum bid lower than a non-subscriber, the user C has a higher ratio of bids than the other users A and B. However, by inputting a requested bid so that the non-subscriber D may have a high ratio in spite of an unfavorable lowest bid, the fleet system may determine the non-subscriber as a final purchaser and set the requested bid of the non-subscriber D as final purchase price information.

Meanwhile, in the embodiment of FIG. 12B, a process of determining a purchaser in an auction procedure is illustrated in which only users participate in the purchase but a non-subscriber does not participate in the purchase. Due to the rise of actual secondhand sales prices of shared moving objects and users' preference, the fleet system may determine that disposing under a condition favorable to an operator is appropriate. When thus determining, the fleet system may perform an auction procedure by a disposing process rather than by the purchase priority method according to FIG. 10. Still, in order to provide a purchase benefit to a user with high usage, the fleet system may set a minimum bid to decrease along with an increase of usage, as shown in FIG. 12A.

The process of FIG. 12B shows that after receiving requested bids from devices of users, a purchaser and purchase price information are determined like in the step S415 of FIG. 11.

When the requested bids of users are simply compared in FIG. 12B, the requested bid of the user C is highest, but in order to provide a purchase benefit to a user with high usage, the fleet system may determine a purchaser by considering each user's usage. In this case, like in FIG. 12A, the fleet system may also determine a user, who has a highest ratio (b/a) of a minimum bid reflecting usage and a requested bid, as a purchaser. As the user A registers a requested bid based on a benefit of usage, that is, based on a minimum bid lower than other users, the user A has a higher ratio of bids than the other users B and C. Accordingly, the fleet system may determine the user A as a final purchaser and the corresponding requested bid as final purchase price information.

This embodiment also shows an example of determining a purchase according to a ratio between a minimum bid and a requested bid but is not limited thereto, and various types of determination processes including a factor considering usage may be applied as long as they offer a purchase benefit to a user of a shared moving object. Furthermore, based on an embodiment according to FIG. 12B, the purchase benefit of a user with highest usage and the benefit of an operator may obtain adequate balance.

The embodiment above described an auction process including a user and a non-subscriber who participated in the purchase, but a disposing process including a non-user and/or a non-subscriber participating in the purchase together with a user or including a non-user and/or a non-subscriber participating in the purchase may also be performed by an embodiment of FIG. 11 and FIG. 12. When a non-user and a non-subscriber participate in the purchase, the fleet system may transmit a purchase benefit according to subscription to service, for example, an estimated price of residual value and a lowest bid, which are lower than those of the non-subscriber, to a device. In addition, the fleet system may provide each of a multiplicity of non-users with purchase benefits that are differentiated according to usage, rating information and use pattern information for other moving objects. In addition to this, the fleet system may identify a non-user's moving object of interest that is estimated according to preference information, history information and use pattern information, and when a disposal due date of a shared moving object similar to the moving object of interest is imminent, may notify the plan of participating in the purchase of the shared moving object to the non-user.

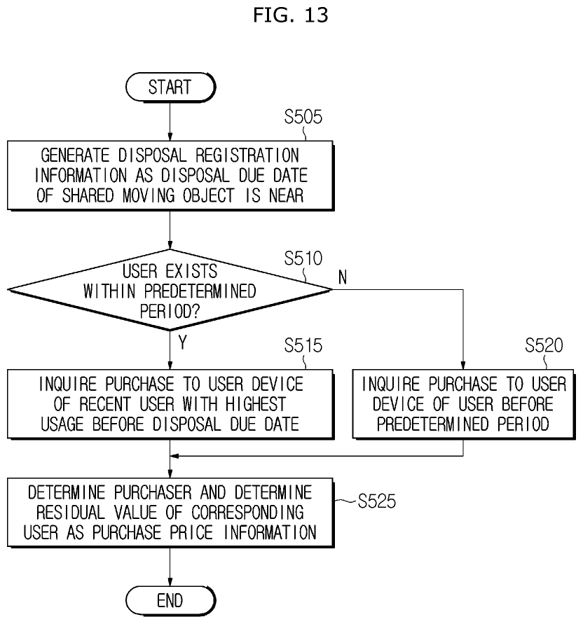

As an embodiment different from the auction process of FIG. 11 and FIG. 12, the embodiment below will describe provision of purchase priority to a latest user within a service period of a shared moving object. FIG. 13 is a flowchart showing yet another example of a purchase process of a shared moving object according to embodiments of the present disclosure.

First, when a disposal due date of a shared moving object is near and disposal registration information is generated (S505), a fleet system may determine whether or not there is a user of the shared moving object within a predetermined (recent) period close to the disposal due date (S510). The predetermined period may be extended or reduced depending on the actual sales price and recent preference of the shared moving object.

As a result of determination, when there is a recent user, a message of purchase request may be first transmitted to a device of a user who is identified to obtain highest usage within the predetermined period (S515).

When asking to purchase, the fleet system may calculate an estimated price of residual value in a similar method to FIGS. 7A to 8A, generate a purchasable price based on the estimated price as benefit information and transmit the purchasable price information to a device. As the recent user is more likely to purchase than a past user and used a shared moving object with decreasing preference and use rate, the recent user may have purchase priority even though the recent user has lower usage than the past user.

Like in FIG. 10, the fleet system may present information on the moving object and the purchase inquiry to a recent user with highest usage. In addition, in order to encourage purchase, information on the rankings of recent users (including the user with highest usage) and purchasable prices may be provided to the user with highest usage. The rankings and purchasable prices of the other recent users (excluding the user with highest usage) may be provided to a recent user with low priority, who is willing to participate in the purchase but to whom the purchase inquiry is not transmitted.

Like in the step S315 of FIG. 10, the fleet system may check whether or not the recent user with highest usage accepts the purchase request and, when the recent user with highest usage registers the acceptance of the purchase request, may determine the recent user with highest usage as a purchaser and determine an estimated price of residual value, which is presented to the user as a purchasable price, as final purchase price information (S525).

On the other hand, in case the user with highest usage does not accept the purchase request, the fleet system may transmit a message requesting purchase to a recent user securing second-top usage, like in the step S320 of FIG. 10. As described above, the purchase inquiry may include a purchasable price and information on the moving object.

Subsequently, the fleet system may check whether or not there is a purchase acceptance request of the user ranked second like in the case of the user with highest usage. In case the acceptance request is present, the user ranked second and a corresponding purchasable price may be determined as a final purchaser and purchase price information. In case there is no acceptance request, the same purchase inquiry, confirmation of acceptance and determination of purchase as in the above-described step may be performed for a user ranked next.

Meanwhile, when it is confirmed that there is no recent user of the shared moving object, the fleet system may transmit a message requesting purchase to a user of a period preceding the predetermined period to a device (S520).

When there is no recent user, this case may include a situation in which there is actually no user during the period and a situation in which the recent users do not accept request of purchase. A purchase inquiry for a user before the predetermined period and a disposing process may be performed by one of the processes of FIGS. 9 to 12.

As another embodiment, the fleet system may check whether or not there is a recent user and, when there is a recent user, may determine whether or not the recent user's estimated price of residual value is below a threshold value. As a weight applied according to age of a shared moving object is considerably high like in FIG. 8A and FIG. 8B, the above embodiment is more useful for a case in which an estimated price of residual value is remarkably lower than an actual sales price and recent preference. In case the recent user's estimated price of residual value is below a threshold value that is calculated according to an actual sales price and preference, the fleet system may proceed with a disposing process of generating purchase benefit information covering a user in a whole service period and providing the information to the user thus covered. Accordingly, without implementing the step S515, in which a recent user purchases sales priority, a purchase inquiry and a disposing process may be performed by one of the processes of FIGS. 9 to 12, instead of the step S520.

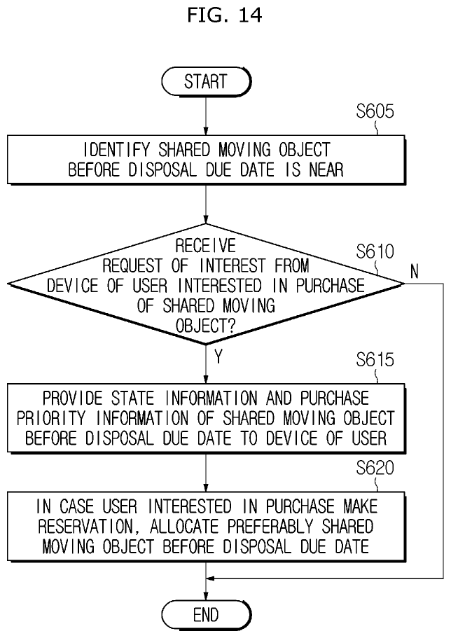

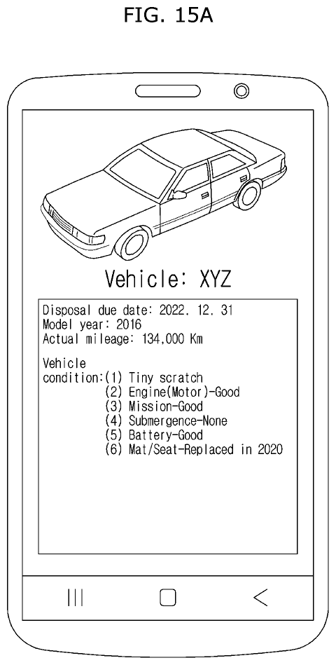

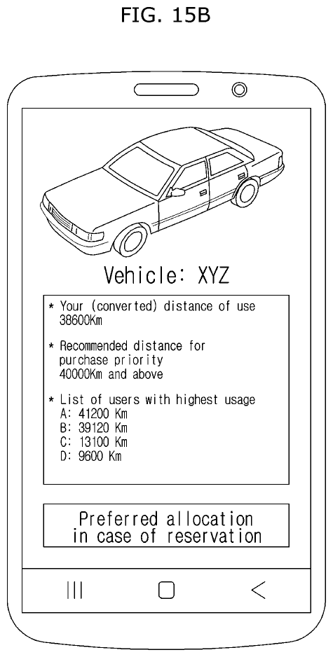

Hereinafter, referring to FIG. 14 and FIG. 15B, allocation of a shared moving object to a user interested in purchase will be described according to an embodiment of the present disclosure.

FIG. 14 is a flowchart regarding allocation of a shared moving object to a user interested in purchase according to embodiments of the present disclosure. FIG. 15A and FIG. 15B are views showing examples of information provided to a user device of a user interested in a purchase.

A fleet system may identify a shared moving object before its disposal due date (S605).

The disposal due date may be an age of the shared moving object and may also be determined according to mileage, state, users' preference, release of a new moving object in the same category, and ease of change of parts. The moving object before the disposal due date may be a moving object in a predetermined period before a due time of disposal.

Next, the fleet system may check whether or not there is a user interested in purchasing the shared moving object before the disposal due date (S610).

This may be a method of identifying the interest of a service subscriber in a purchase interest message for the shared moving object, which the subscriber directly requests via a user device, or a method of determining a purchase possibility from the preference information, history information, use pattern information and rating information of a user utilizing the shared moving object, which are requested to a user device.

As an example, a method of determining a purchase possibility may consider a request of interest directly from a repeated request of a user device, and the purchase possibility may be determined, for example, based on the distance of use, period of use and times of use, which are used to calculate the usage of the moving object. As another example, among moving objects used by a user, a moving object with relatively high frequency of usage and a moving object, which is frequently utilized in a special situation identified based on the life pattern information and riding pattern information of the use pattern information, may have a high possibility to be purchased by the user. As yet another example, a moving object with relatively higher usage than another user may have a high possibility of purchase. As yet another example, in case a user uses a specific moving object better than other moving objects and the rating information of the specific moving object is remarkably higher than the other moving objects, the specific moving object may have a high possibility of purchase. As yet another example, in case the user has not used the moving object but has had high usage of another moving object of an equivalent type, it is possible to determine that the moving object has a high possibility of purchase. As yet another example, in case the user has intensively used a shared moving object within a recent period before a disposal due date, although the period is short compared to a whole service period, the user's possibility of purchasing the shared moving object may be determined to be high. Purchase possibility is not limited to the above-described example but may be inferred in various methods.

As a checking result, when there is a user interested in purchase, the fleet system may provide the state information and purchase priority information of the shared moving object via a user device of the interested user (S615).

As illustrated in FIG. 15A and FIG. 15B, the fleet system may provide a due date of disposal, model year and actual mileage via a device of an interested user. In addition, the fleet system may provide information on a state of the moving object such as an exterior defect, a condition of the driving system, and sensibility deterioration states identified by a mat and a seat via the user device. In addition, the fleet system may provide not only a distance of use, which is presented as an example of usage in FIG. 7 and FIG. 8, but also multiple users' usage as purchase priority information indicating whether or not a purchase priority benefit is available. Furthermore, the fleet system may show, as purchase priority information, an accumulated distance of use, for which a purchase priority is generated and given by applying a weight according to the passage of life, on the user device.

FIG. 15B takes a distance of use as an example, but estimated prices of residual value and lowest bids for multiple users including a corresponding user may be provided. In this case, an estimated price of residual value may be an estimated price at present or an estimated price at a due point of disposal, which is estimated by analyzing a use trend according to each user. A minimum bid may also be calculated based on an estimated price at present or at a due point of disposal.

Next, in case allocation requests of a multiplicity of users may compete for a shared moving object and the user interested in purchase is included in the multiplicity of users, the fleet system may allocate the shared moving object preferably to the user interested in purchase (S620).

Furthermore, in case there are a multiplicity of users interested in purchase, the fleet system may allocate the shared moving object preferably to an interested user with highest possibility of purchase. As an example, when a user expresses his interest in purchase directly through the fleet system, it may be determined that the user directly expressing his interest has a higher possibility of purchase than an interested user who is estimated indirectly through possibility determination, and the fleet system may allocate the shared moving object preferably to the user directly expressing his interest. As another example, in case a multiplicity of users, who are indirectly determined to be interested in the purchase, request allocation, the fleet system may allocate the shared moving object preferably to a user with highest possibility based on purchase possibilities that are quantified by the above-described example.

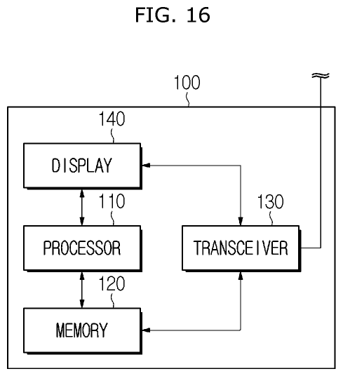

FIG. 16 is a view showing a device configuration according to embodiments of the present disclosure. Referring to FIG. 16, the device may include at least one or more among the above-described moving object, a device, a server and an RSU. In other words, the device may communicate and work with another device, which is not limited to the above-described embodiment. As an example, for the above-described operation, the device 100 may include one or more among a processor 110, a memory 120, a transceiver 130 and a display 140. That is, the device may include a configuration necessary to communicate with another device or may display a data processing result between each other. In addition, as an example, the device may include other configurations than the above-described configuration. That is, the device may have a configuration, which includes the above-described device for communicating with other devices but is not limited thereto, and may be a device operating based on what is described above.

Effects obtained in embodiments of the present disclosure are not limited to the above-mentioned effects, and other effects not mentioned above may be clearly understood by those skilled in the art from the above description.

While the exemplary methods of embodiments of the present disclosure described above are represented as a series of operations for clarity of description, it is not intended to limit the order in which the steps are performed, and the steps may be performed simultaneously or in different order as necessary. In order to implement the method according to embodiments of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for disposing of a shared moving object, the method comprising:
generating disposal registration information designating the shared moving object as an item for disposal based on a disposal due date of the shared moving object;
generating market price information of the shared moving object;
analyzing usage of the shared moving object according to each user device registered to a fleet system;
evaluating a residual value of the shared moving object according to the usage of each user device;
generating purchase benefit information of the shared moving object according to the usage;
transmitting the purchase benefit information for display on the user device; and
determining purchase price information according to a price based on the residual value.

2. The method of claim 1, wherein evaluating the residual value of the shared moving object according to the usage of each user device comprises:
calculating the residual value to be lower than the market price information; and
calculating the residual value to decrease or increase according to the usage.

3. The method of claim 1, wherein evaluating the residual value of the shared moving object according to the usage of each user device comprises:
calculating the residual value to be lower than the market price information;
applying a weight to the usage as the disposal due date becomes closer; and
evaluating the residual value according to the usage to which the weight is applied.

4. The method of claim 1, wherein the usage comprises a distance of use, a use period, or a number of times of use for the shared moving object, wherein the usage is aggregated according to each user device.

5. The method of claim 1, wherein generating the purchase benefit information of the shared moving object according to the usage comprises giving a purchase priority to a user with highest usage among a multiplicity of users.

6. The method of claim 5, wherein determining the purchase price information according to the price based on the residual value comprises determining an estimated price corresponding to the residual value for the user accepting purchase at the request of the user device as the purchase price information.

7. The method of claim 1, wherein determining the purchase price information according to the price based on the residual value comprises:
determining that the purchase proceeds by an auction in response to a multiplicity of requests of user devices participating in the purchase of the shared moving object;
determining a minimum bid of each request of the multiplicity of the user devices based on the residual value;
receiving a requested bid equal to or greater than the minimum bid from the multiplicity of the user devices;
determining a purchaser based on the minimum bid and the requested bid;
notifying the purchaser via the user devices; and
determining the purchaser's requested bid as the purchase price information.

8. The method of claim 7, wherein determining the minimum bid comprises setting the minimum bid to decrease as the usage increases.

9. The method of claim 7, wherein determining the purchase price information comprises determining as the purchaser a user for whom a ratio of the requested bid for the minimum bid is determined to be highest.

10. The method of claim 7, wherein receiving the requested bid comprises providing other users' requested bids and expected purchase rankings to the user device in response to a user inputting the requested bid via the user device.

11. The method of claim 7, wherein the auction is set to proceed with a user and a non-user not registered to the fleet system participating in the auction.

12. The method of claim 1, wherein generating the purchase benefit information of the shared moving object comprises offering a purchase priority to a user within a predetermined period close to the disposal due date during a service period of the shared moving object.

13. The method of claim 12, wherein, in response to the residual value within the predetermined period being equal to or less than a threshold value, the purchase benefit information is generated by expanding to a second user using during an entire service period and is provided to the user device of the second user.

14. The method of claim 12, wherein:
the usage comprises a distance of use or a number of times of use for the shared moving object which are aggregated according to each of the user devices; and
a ranking of purchase priority is given according to the usage.

15. The method of claim 1, further comprising allocating to a user interested in a purchase, in response to receiving a request of interest from the user device of the user interested in the purchase of the shared moving object before the disposal due date and identifying the user interested in the purchase and receiving allocation requests from a multiplicity of user devices competing for the shared moving object.

16. The method of claim 15, further comprising providing state information and purchase priority information of the shared moving object via the user device of the user interested in the purchase before allocating to the user interested in the purchase.

17. A server configured to evaluate a residual value of a shared moving object and to sell the shared moving object in a fleet system, the server comprising:
a transceiver configured to transmit and receive a signal; and
a processor configured to:
control the transceiver;
generate disposal registration information designating the shared moving object as an item for disposal based on a disposal due date of the shared moving object;
provide market price information of the shared moving object;
analyze usage of the shared moving object according to each user device registered to the fleet system;
evaluate the residual value of the shared moving object according to the usage of each user device;
generate purchase benefit information of the shared moving object according to the usage;
transmit the purchase benefit information to be displayed on the user device; and
determine purchase price information according to a price based on the residual value.

18. The server of claim 17, wherein evaluating the residual value of the shared moving object according to the usage of each user device comprises:
calculating the residual value to be lower than the market price information; and
calculating the residual value to decrease or increase according to the usage.

19. The server of claim 17, wherein evaluating the residual value of the shared moving object according to the usage of each user device comprises:
calculating the residual value to be lower than the market price information;
applying a weight to the usage as the disposal due date becomes closer; and
evaluating the residual value according to the usage to which the weight is applied.

20. A fleet system configured to evaluate a residual value of a shared moving object and to sell the shared moving object, the fleet system comprising:
a user device registered to the fleet system;
the shared moving object registered to the fleet system; and
a server configured to manage the fleet system, wherein the server is configured to:
generate disposal information designating the shared moving object as an item for disposal in response to a disposal due date of the shared moving object;
provide market price information of the shared moving object;
analyze usage of the shared moving object according to each user device registered to the fleet system;
evaluate the residual value of the shared moving object according to the usage of each user device;
generate purchase benefit information of the shared moving object according to the usage;
transmit the purchase benefit information to be displayed on the user device; and
determine purchase price information according to a price based on the residual value.
